(19) United States
(12) Patent Application Publication
(10) Pub. No.: US 2006/0143565 A1
(43) Pub. Date: Jun. 29, 2006

(54) Method to promote branded products and/or services

(75) Inventor: Courtney P. Jones, Ft. Myers, FL (US)

Correspondence Address: HAHN LOESER & PARKS, LLP, One GOJO Plaza, Suite 300, AKRON, OH, 44311-1076, US

(73) Assignees: Blu Ventures, LLC; ioMedia Partners, LLC

(21) Appl. No.: 11/182,716

(22) Filed: Jul. 15, 2005

Related U.S. Application Data
(60) Provisional application No. 60/588,565, filed on Jul. 16, 2004.
(60) Provisional application No. 60/588,934, filed on Jul. 16, 2004.
(60) Provisional application No. 60/588,568, filed on Jul. 16, 2004.
(60) Provisional application No. 60/588,567, filed on Jul. 16, 2004.
(60) Provisional application No. 60/588,566, filed on Jul. 16, 2004.

(51) Int. Cl. G06F 15/16

(52) U.S. Cl. 715/717; 709/231

(57) ABSTRACT

A method to promote branded products and/or services is disclosed. The method includes integrating a brand-specific graphical user interface with a global informational networked-based media station resulting in an integrated web site. The integrated web site is accessible via a global informational network (e.g., the Internet) using a personal computer (PC) system connected to the global informational network. The brand-specific graphical user interface is displayed on a screen of the PC system to a user and streaming digital media content (provided by the network-based station) is played on the PC system.

### CROSS-REFERENCE TO RELATED APPLICATIONS/INCORPORATION BY REFERENCE

This application claims priority to the following U.S. patent applications:

U.S. patent application Ser. No. 10/664,407, entitled “A Method for Operating an Internet Broadcasting Station” filed on Sep. 19, 2003, which is incorporated herein by reference in its entirety.

U.S. provisional patent application Ser. No. 60/547,765 filed Feb. 25, 2004 and U.S. patent application Ser. No. 11/066,623 filed Feb. 25, 2005, both entitled “Methods to Adapt Search Results Provided by an Integrated Network-Based Media/Search Engine Based on User Lifestyle”, both of which are incorporated herein by reference in their entirety.

U.S. Provisional Patent Application Ser. No. 60/588,934, entitled “Methods to Adapt Search Results Provided by an Integrated Network-Based Media Station/Search Engine Based on User Lifestyle” filed Jul. 16, 2004, which is incorporated herein by reference in its entirety.

U.S. Provisional Patent Application Ser. No. 60/588,565, entitled “A Method to Access and Use an Integrated Web Site in a Mobile Environment” filed Jul. 16, 2004, which is incorporated herein by reference in its entirety.

U.S. Provisional Patent Application Ser. No. 60/588,568, entitled “A Method to Generate Revenue for a Global Informational Network-Based Media Provider” filed Jul. 16, 2004, which is incorporated herein by reference in its entirety.

U.S. Provisional Patent Application Ser. No. 60/588,566, entitled “Systems and Methods to Provide Internet Search/Play Media Services” filed on Jul. 16, 2004, which is incorporated herein by reference in its entirety.

U.S. Provisional Patent Application Ser. No. 60/588,567, entitled “Method to Promote Branded Products and/or Services” filed on Jul. 16, 2004, which is incorporated herein by reference in its entirety.

### TECHNICAL FIELD

Certain embodiments of the present invention relate to advertising and media program broadcasting. More particularly, certain embodiments of the present invention relate to a method to promote branded products and/or services via a global informational network-based media station.

### BACKGROUND OF THE INVENTION

Traditional broadcasting, such as radio or television, combines programming content (such as entertainment content or news content) with commercial advertising content. Programming content is periodically interrupted by commercial advertising content in units of, typically, 30 seconds and 60 seconds to generate income for the broadcasting station and provide brand recognition for advertisers. A user of the broadcast is forced to wait until the commercial advertising segment is finished before he is able to resume consumption of programming content.

Public broadcasting, such as public radio or TV, typically depends upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

On the Internet, search engines are used to find sources of information, media content, and advertisers. Advertisers pay the provider of the search engine to be found and are ranked according to bid, with the highest bid appearing first in a search list on the users PC (personal computer) screen. U.S. Pat. No. 6,269,361 describes such a bidding methodology.

Users enter key search words to perform a search and the search engine provides a list of search results in the form of links to web sites. One of the drawbacks of current search engines is that they typically do not take into consideration any information about the user to provide a better search result that is more pertinent to the user's interests. A search engine may simply “know” that users who have searched for “A” have also searched for “X”, “Y”, and “Z”. Searching today provides mostly sterile and often static listings of URL's that point to sites based on a Boolean search. Results often lack any real relevancy and often, users have to refine and refine to finally get what they are looking for.

Internet radio stations provide programming content and allow advertisers to provide “pop -up” icons that a user can click on to go to the web sites of the advertisers. Internet radio stations often require users to subscribe to the radio station in order to access programming content of the radio station. The subscription usually involves paying a fee. When a user accesses an Internet radio station, a commercial media player on the user's personal computer is typically launched in order to play streaming digital audio from the Internet radio station. Some Internet radio stations also broadcast through access providers, such as America Online (AOL) or the like, which requires a subscription. Thus, the users of the site pay a fee in order to access programming content of the radio station.

Further limitations and disadvantages of conventional, traditional, and proposed approaches will become apparent to one of skill in the art, through comparison of such systems with the present invention as set forth in the remainder of the present application with reference to the drawings.

### BRIEF SUMMARY OF THE INVENTION

An embodiment of the present invention comprises a method to promote branded products and/or services. The method comprises integrating a customized, brand-specific graphical user interface with a global informational network-based media station resulting in an integrated web site that is accessible via a global informational network. The method further comprises accessing the integrated web site via the global informational network using a personal computer (PC) system connected to the global informational network and displaying the brand-specific graphical user interface on a screen of the PC system. The method also includes playing streaming digital media content, provided by the network-based media station to the PC system, on the PC system.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an embodiment of a personal computer (PC) system displaying a brand-specific graphical user interface view, in accordance with various aspects of the present invention.

FIG. 2 illustrates an embodiment of a system providing streaming digital media content and a brand-specific graphical user interface view to the PC system of FIG. 1, in accordance with various aspects of the present invention.

FIG. 3 is a flowchart of an embodiment of a method to promote a brand using the system of FIG. 2, in accordance with various aspects of the present invention.

FIG. 4 illustrates an embodiment of an integrated media player/brand-specific graphical user interface view provided by the system of FIG. 2, in accordance with various aspects of the present invention.

### DETAILED DESCRIPTION OF THE INVENTION

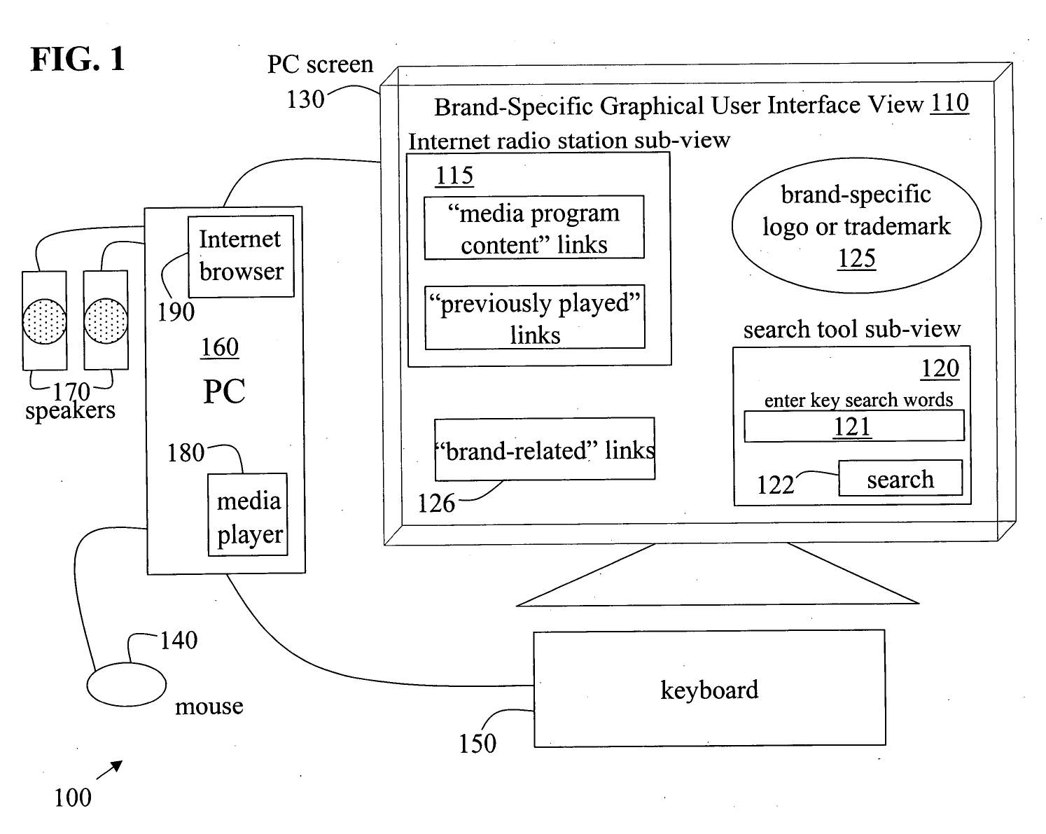

FIG. 1 illustrates an embodiment of a personal computer (PC) system 100 displaying a brand-specific graphical user interface view, in accordance with various aspects of the present invention. The brand-specific graphical user interface view 110 includes a global informational network (e.g., Internet) radio station sub-view 115, a search tool sub-view 120, a brand-specific logo or trademark 125, and a set of brand-related links 126 displayed on a screen 130 of the PC system 100.

The PC system 100 includes the screen 130, a mouse 140, a keyboard 150, a PC processing unit 160, and speakers 170. The PC screen 130, the mouse 140, the keyboard 150, and the speakers 170 each interface to the PC processing unit 160. The PC processing unit 160 includes a media player module 180 capable of processing and playing digital streaming media such as, for example, streaming audio and/or streaming video. The PC processing unit 160 also includes a global informational network browser 190 capable of accessing web addresses on a global informational network (e.g., the Internet).

In accordance with an embodiment of the present invention, the media player module 180 comprises a software application residing within the PC processing unit 160 and the web browser 190 comprises a software application residing within the PC processing unit 160.

Other PC systems are possible as well, in accordance with various embodiments of the present invention, including wireless and hand-held PC systems (e.g., a wireless personal digital assistant (PDA) in communication with the Internet). In accordance with an embodiment of the present invention, the PC system 100 comprises an off-the-shelf, commercially available PC system having an off-the-shelf, commercially available browser 190.

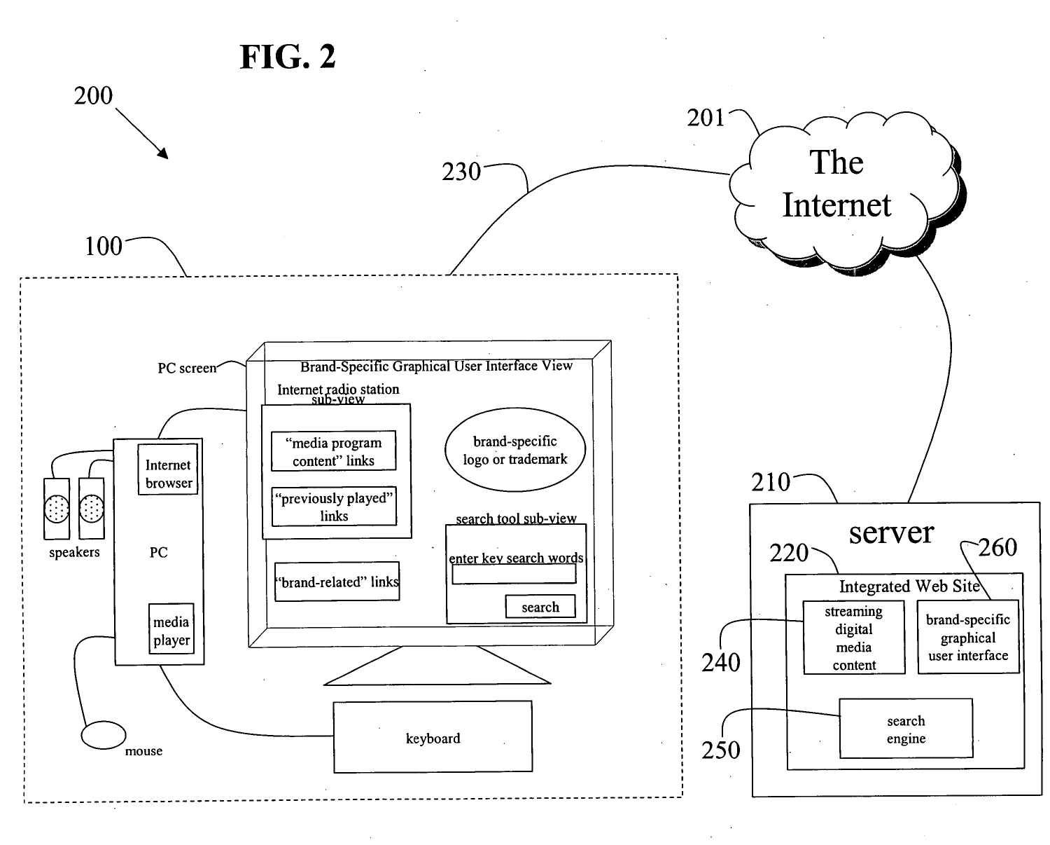

FIG. 2 illustrates an embodiment of a system 200 providing streaming digital media content and a brand-specific graphical user interface view to the PC system 100 of FIG. 1, in accordance with various aspects of the present invention. The system 200 comprises the Internet 201 (i.e., a global informational network) and at least one server 210. The server 210 interfaces to the Internet 201. The server 210 hosts an integrated web site 220 which provides the brand-specific graphical user interface view 110 of FIG. 1, in accordance with various aspects of the present invention. In accordance with an alternative embodiment of the present invention, the system 200 also includes a database interfacing to the server 210. The integrated web site 220 is accessed via the PC system 100 using the Internet browser 190.

The integrated web site 220 integrates streaming digital media content 240, a brand-specific graphical user interface 260, and a search engine capability 250, in accordance with an embodiment of the present invention.

The present invention is not limited to the type of media consumed by the user, and although examples may relate to embodiments of Internet radio and the like, any other media consumed by users is contemplated herein. For example, a user may access media in the form of an on-line book or on-demand media, wherein the subject matter of the book, the author or other attributes of the material is used to provide search results according to the invention. Thus, a user may be accessing media at sites like Amazon.com or the like, and the concepts of the invention implemented to provide search information to the user according to the invention. Alternatively, the user may access media via a site such as Encarta.com, wherein the user may access media via the on-line encyclopedia, and the media used to provide search results according to the invention. For example, the user may view of photograph of the Mona Lisa, with search results generated according to the invention to provide information on the artist, period of other aspects related to this content. Thus, as should be evident, any type of media consumed by a user is contemplated in the invention.

Referring to FIG. 2, a user of the PC system 100 connects to the Internet 201 via traditional means such as a dial-up connection or a cable modem connection 230, for example, and accesses the integrated web site 220. The connection to the Internet 201 may be wired or wireless. In accordance with an embodiment of the present invention, the integrated web site 220 is hosted on the server 210 on the Internet 201 and is configured as an Internet radio station that provides various streaming digital media content 240 (such as, for example, music) and various display views (e.g., 110) to the PC system 100 via the established Internet connection.

The integrated web site 220 also comprises an integrated search engine 250 corresponding to the search tool sub-view 120. In accordance with various alternative embodiments of the present invention, the Internet 201 may instead comprise some other global informational network. In general, streaming digital media content comprises at least one of streaming digital audio or streaming digital video in the form of, for example, musical pieces (e.g. songs), human discourse (e.g., talk radio), television programs, music videos, news programs, etc.

The brand-specific graphical user interface view 110 provided by the integrated web site 220 is displayed on the screen 130 of the PC system 100 to the user. In accordance with an embodiment of the present invention, the brand-specific graphical user interface view 110 includes an Internet radio station sub-view 115 with various link choices (e.g., “media program content” links, “previously played” links, etc.) and a search tool sub-view 120. The user interface view 110 also provides “brand-related” links 126. The various link choices are provided by the integrated web site 220 to the PC system 100.

The brand-specific logo or trademark 125 and the brand-related links 126 promote goods and/or services of, for example, a public corporation or a private business. The Internet radio station and search capability format provided by the integrated web site 220 is primarily a tool provided by, for example, the public corporation to promote the branded products and/or services of the public corporation other than the integrated web site 220 itself (i.e., other than the Internet radio station with search capability).

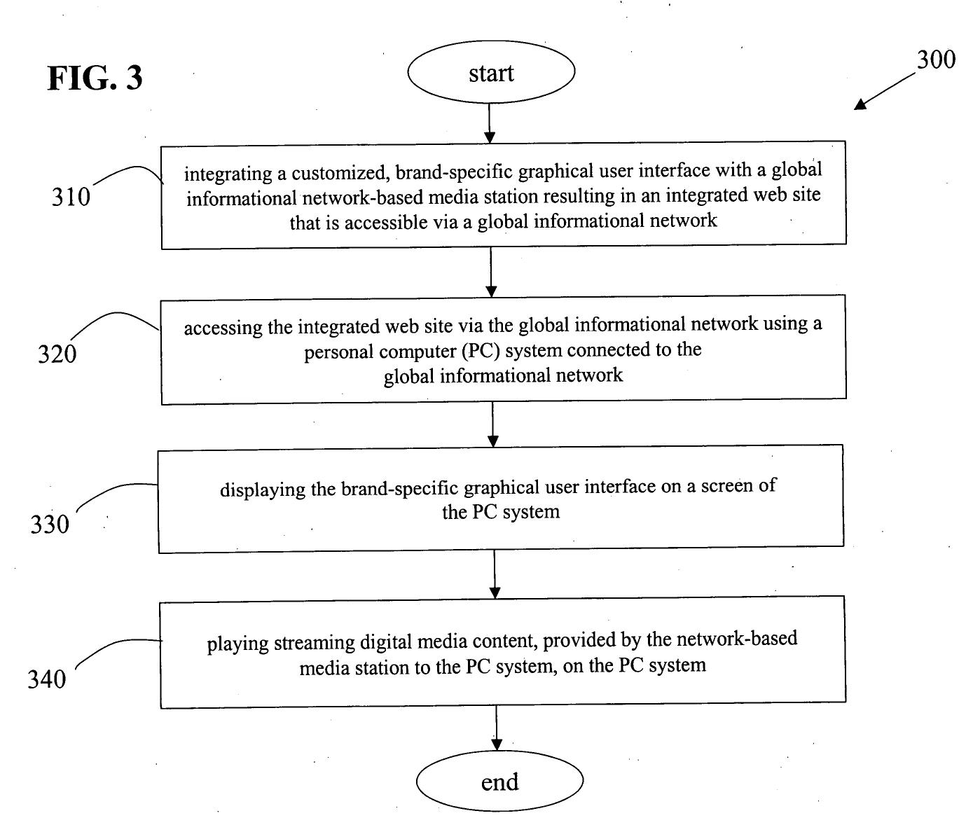

FIG. 3 is a flowchart of an embodiment of a method 300 to promote a brand using the system 200 of FIG. 2, in accordance with various aspects of the present invention. In step 310, a customized, brand-specific graphical user interface is integrated with a global informational network-based media station resulting in an integrated web site that is accessible via a global informational network. In step 320, the integrated web site is accessed via the global informational network using a personal computer (PC) system connected to the global informational network. In step 330, the brand-specific graphical user interface is displayed on a screen of the PC system. In step 340, streaming digital media content is provided by the network-based media station to the PC system and played on the PC system.

For example, when a user clicks on a “media program content” link, streaming digital media content 240 is routed from the server 210 to the PC 100 via the Internet 201. The media player 180 is launched within the PC system 100 and receives and plays the streaming digital media content 240 (e.g., a musical piece) through the speakers 170.

The “media program content” link choices displayed in the sub-view 115 include, for example, links to individual musical pieces or songs, an album of musical pieces or songs, songs of a particular artist, a category or genre of musical pieces or songs, talk radio shows, news, etc. For example, a first media program content link is the category of music called “Classic Rock”. When a user clicks on the “Classic Rock” category, streaming digital audio of classic rock music is transmitted from the server 210 to the PC system 100. Alternatively, when a user clicks on the “Classic Rock” category, another set of links is displayed to the user which provides choices of individual musical artists that the user may select. Other arrangements are possible as well, in accordance with various embodiments of the present invention.

The search tool sub-view 120 includes a text entry area 121 to enter key search words, and a “search” or “go” button 122 to initiate a search. A user may use the mouse 140 or the keyboard 150 of the PC system 100 to select any of the link choices and to enter key search words in the text entry area 121 to perform a search on the Internet 201. In accordance with an embodiment of the present invention, at least the entire World Wide Web (WWW) is available for searching via the search tool sub-view 120 using the search engine 250.

In accordance with an embodiment of the present invention, the user may search the Internet 201 using the search engine 250 while listening to the streaming digital media program content without interrupting the streaming digital media program content. The user may proceed to input key search words into the search tool sub-view 120 using, for example, the keyboard 150 in order to look for other web sites on the Internet 201. The web sites that a user may search for may include many different types of web sites that are hosted on the Internet 201, including web sites of advertisers who are sponsors of the Internet radio station.

As an example, referring to FIG. 2, a user of the PC system 100 accesses the integrated web site 220 (e.g., an Internet radio station) and views the brand-specific graphical user interface view 110. The user then clicks on a “media program content” link, for example, to initiate the reception of streaming digital audio, via the Internet 201, from the server 210 which is hosting the integrated web site 220 (i.e., the Internet radio station). Once the user is comfortably listening to the selected media program content (which is, for example, classical music), the user then begins entering key search words into the search tool sub-view 120 to leisurely search the Internet 201 while listening to the streaming audio.

Also, in accordance with an embodiment of the present invention, the user may click on various link choices in the view 110 while listening to the streaming digital media program content without interrupting the streaming digital media program content. The user may proceed to click on links using, for example, the mouse 140 in order to access other web pages of the integrated web site 220 or to access other web sites on the Internet 201. The various link choices may include links to other streaming media program content, links to other web pages of the integrated web site 220 (i.e., brand-related links 126), links to other web sites on the global informational network (e.g., the Internet 201), and links to other links.

As an example, referring to FIG. 2, a user of the PC system 100 accesses the integrated web site 220 (e.g., an Internet radio station) and views the brand-specific graphical user interface view 110. The user then clicks on a “media program content” link, for example, to initiate the reception of streaming digital audio, via the Internet 201, from the server 210 which is hosting the integrated web site 220 (i.e., the Internet radio station). Once the user is comfortably listening to the selected media program content (which is, for example, a talk radio show), the user then begins to click on “brand-related” links 126 while listening to the streaming audio.

For example, if the integrated web site 220 is provided by a beer company, then the logo and/or trademark 125 corresponds to a brand of the beer company. A first “brand-related” link takes a user to, for example, web pages of the beer company that advertise the beer company's secondary products such as T-shirts, mugs, etc. A second “brand-related” link takes the user to the corporate web site of the beer company. A third “brand-related” link takes the user to a new set of links that each promote a different sporting event sponsored by the beer company.

Other entities that may provide an integrated web site 220 for the purpose of promoting brands include colleges and universities, professional sports teams, or any other entity that brands products and/or services.

As a further example, referring to FIG. 2, a user of the PC system 100 accesses the integrated web site 220 (e.g., an Internet radio station) and views the brand-specific graphical user interface view 110. The user then clicks on a “media program content” link, for example, to initiate the reception of streaming digital audio, via the Internet 201, from the server 210 which is hosting the integrated web site 220 (i.e., the Internet radio station). Once the user is comfortably listening to the selected media program content (which is, for example, a song of a rock-n-roll artist), the user then begins to click on other links related to the artist (e.g., tickets to concerts, biography of the artist, new album of the artist, etc.) while listening to the streaming audio.

In accordance with an alternative embodiment of the present invention, the integrated web site 220 also provides a directory of commercial advertisements that a user of the PC system 100 may access and view. The commercial advertisements take many forms including streaming digital audio, streaming digital video, an HTML web page, etc., and promote products and/or services of the entity providing or sponsoring the integrated web site 220.

In accordance with an embodiment of the present invention, a radio announcer for the Internet radio station periodically encourages the user to click on “brand-related” links 126 and/or perform searches using the search tool sub-view 120 and the associated search engine 250 provided by the integrated web site 220, or to click on other link choices provided.

In accordance with an alternative embodiment of the present invention, the integrated web site 220 provides an Internet television station, broadcasting streaming video and audio over parts of the Internet 201 that provide enough bandwidth to accommodate the video and audio programming. The Internet television station operates in a similar manner to an Internet radio station (i.e., providing a brand-specific graphical user interface, a search capability, and links).

The main television programming content picture is reduced in size and displayed on the screen 130 to a user in a picture-in-picture (PIP)-type window when the user uses the search engine 250 or chooses to view a commercial advertisement. The main display area of the screen 130 is then used to display the resultant search view or the selected commercial advertisement. Alternatively, the search view or commercial advertisement is displayed in a PIP-type window while the main television programming content picture remains in the main display area of the screen 130. Other user display options are possible as well. The television programming content includes, for example, news video clips or television shows.

As another alternative embodiment, the integrated web site 220 provides an integrated web browser and media player (IWBMP) that can be downloaded to the user's PC 100 via the Internet 201. The IWPMP provides a graphical user interface that is customized to be brand-specific, providing a unique “look and feel”. The IWPMP, once downloaded, is then used to access and play the streaming digital media program content 240, to access “brand-related” links 126, and to search using the search engine 250 on the integrated web site 220.

As a further alternative embodiment of the present invention, the integrated web site 220 integrates a media player user interface with the brand-specific graphical user interface view 110. The integrated media player user interface/brand-specific graphical user interface view is downloaded to the user's PC system 100 and is used at least to access and play streaming digital media program content 240, to access “brand-related” links 126, and to search using the search engine 250 on the integrated web site 220.

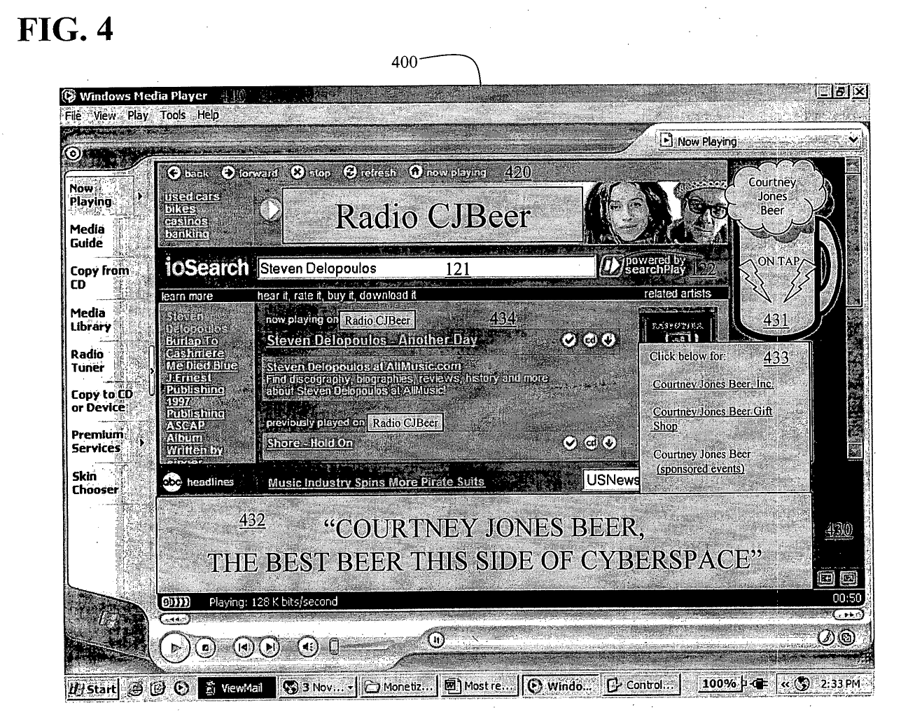

FIG. 4 illustrates an embodiment of an integrated media player/brand-specific graphical user interface view 400 provided by the integrated web site 200, in accordance with various aspects of the present invention. The integrated media player/user interface view 400 includes a commercial media player 410 with associated functionality and a search text entry box 121 and a search initiate button 122 with a navigation tool bar 420. The integrated media player/user interface view 400 also includes a sub-view 430 comprising at least one brand-specific logo or trademark 431, a plurality of “brand-related” links 433 to other web pages, web sites, other links, etc., and a plurality of Internet radio station links 434. Other brand-related graphics and/or text such as, for example, a slogan 432 can also be included as part of the graphical user interface view 110 as provided by the graphical user interface 260.

In accordance with an alternative embodiment of the present invention, the various components of the integrated web site 220 (e.g., the streaming digital media content 240, the search engine 250, the brand-specific graphical user interface 260, and other associated web pages) are hosted on more than one server.

In accordance with an embodiment of the present invention, the global search engine 250 is provided by the provider of the integrated web site 220 as part of the integrated web site 220. However, the integrated web site 220 also provides the option of direct access to other search engines (e.g., Google™, Yahoo®) as well.

In summary, an integrated web site that is accessible via a global informational network using a PC system provides streaming digital media content, search capability, and a brand-specific graphical user interface to promote branded products and/or services of a provider or a primary sponsor of the integrated web site.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to promote branded products and/or services, said method comprising:
integrating a customized, brand-specific graphical user interface with a global informational network-based media station resulting in an integrated web site that is accessible via a global informational network;
accessing said integrated web site via said global informational network using a personal computer (PC) system connected to said global informational network;
displaying said brand-specific graphical user interface on a screen of said PC system; and
playing streaming digital media content, provided by said network-based media station to said PC system, on said PC system.

2. The method of claim I wherein said global informational network comprises the Internet.

3. The method of claim 1 wherein a brand, corresponding to said brand-specific graphical user interface, promotes at least one good and/or service other than said network-based media station.

4. The method of claim 1 wherein said brand-specific graphical user interface includes a logo or trade mark corresponding to a brand which promotes at least one good and/or service other than said network-based media station.

5. The method of claim I wherein said integrated web site includes a downloadable media player software application for playing said streaming digital media content on said PC system.

6. The method of claim I wherein said brand-specific graphical user interface includes a media player user interface for operatively controlling said streaming digital media.

7. The method of claim I wherein said streaming digital media content comprises at least one of streaming digital audio and streaming digital video.

8. The method of claim 1 wherein said network-based media station comprises an Internet radio station.

9. The method of claim I wherein said network-based media station comprises an Internet television station.

10. The method of claim I wherein said integrated web site includes an integrated global search engine to allow a user of said integrated web site to search said global informational network without interrupting said streaming digital media content to said PC system.

11. The method of claim I wherein said integrated web site is hosted on at least one server connected to said global informational network.

12. The method of claim I wherein said brand-specific graphical user interface provides links to at least one of other web pages, other web sites, and other links associated with products and/or services promoted by a brand, other than said network-based media station.

13. The method of claim I wherein said brand-specific graphical user interface provides links to at least one of other web pages, other web sites, and other links not associated with a brand promoted by said brand-specific graphical user interface.

14. The method of claim I wherein said PC system includes a media player software application which is automatically launched in order to play said streaming digital media content on said PC system.

15. The method of claim I wherein said PC system includes a browser software application to allow access to at least said integrated web site on said global informational network.
